(19) United States
(12) Patent Application Publication
(10) Pub. No.: US 2022/0360607 A1
(43) Pub. Date: Nov. 10, 2022

(54) ENTERPRISE BROWSER SYSTEM

(71) Applicant: ISLAND TECHNOLOGY, INC., Dallas, TX (US)

(72) Inventor: DAN AMIGA, RAMAT HASHARON (IL)

(21) Appl. No.: 17/740,457

(22) Filed: May 10, 2022

Related U.S. Application Data
(60) Provisional application No. 63/186,222, filed on May 10, 2021.

(51) Int. Cl. H04L 9/40

(52) U.S. Cl. CPC H04L 63/20; H04L 63/08

(57) ABSTRACT

A web browser including a browser and rendering engine configured to send and receive data via a computer network, and a policy engine configured to implement one or more policies configured to control any aspect of the web browser, the data, a computer that hosts the web browser, and any devices that are accessible to the computer, where the web browser is configured as an executable file that is created by compiling computer software instructions that implement the browser and rendering engine and the policy engine, and where the web browser is configured to require a user of the web browser to be authenticated and one or more policies to be validated before the web browser is allowed to perform one or more predefined operations.

### BACKGROUND

Web browser are among the most widely used computer software applications. Organizations, including commercial business enterprises and government bodies, are increasingly dependent on the use of web browsers by those who work on their behalf. Organizations that wish to exercise control over web browsers, such as to audit their use and prevent them from downloading malware or transmitting sensitive information outside of the organization, are typically forced to implement various measures that are external to web browsers, such as on computers that host web browsers and on network infrastructure through which web browsers communicate. Unfortunately, such measures are often costly and complex to configure and manage, lack visibility to all aspects of internal web browser operation, can impede web browser users from accomplishing their work tasks efficiently, and are too often thwarted by successful attempts to bypass them.

### SUMMARY

In one aspect of the invention a web browser is provided including a browser and rendering engine configured to send and receive data via a computer network, and a policy engine configured to implement one or more policies configured to control any aspect of the web browser, the data, a computer that hosts the web browser, and any devices that are accessible to the computer, where the web browser is configured as an executable file that is created by compiling computer software instructions that implement the browser and rendering engine and the policy engine, and where the web browser is configured to require a user of the web browser to be authenticated and one or more policies to be validated before the web browser is allowed to perform one or more predefined operations.

In another aspect of the invention each of the policies includes one or more policy conditions and one or more policy enforcement actions that are performed when the policy conditions are met.

In another aspect of the invention the web browser is configured to receive the policies from a source that is external to web browser, where the policies are encrypted for decryption using a decryption key that is uniquely associated with an identity that is associated with the user of the web browser, and where the decryption key is provided to the web browser after the user is authenticated.

In another aspect of the invention the web browser is configured to receive from the source browser settings associated with the authenticated user, where the browser settings are encrypted for decryption using the decryption key.

In another aspect of the invention the web browser is configured to at least partially evaluate any of the policies that apply to the data in parallel to receiving the data.

In another aspect of the invention the web browser is configured to at least partially evaluate any of the policies that apply to the data in parallel to receiving the data and in parallel to providing any portion of the data to the browser and rendering engine.

In another aspect of the invention any of the policies includes a policy condition that relates to a category associated with a website accessed by the web browser.

In another aspect of the invention any of the policies includes a policy condition that relates to a risk level associated with a website accessed by the web browser.

In another aspect of the invention any of the policies includes a policy condition that relates to any characteristic of the computer that hosts the web browser.

In another aspect of the invention any of the policies includes a policy condition that relates to any characteristic of identity of the user of the web browser.

In another aspect of the invention any of the policies includes a policy condition that relates to any characteristic of identity of a network that is accessible to the web browser.

In another aspect of the invention any of the policies includes a policy condition that relates to a source of a Uniform Resource Locator (URL) that is provided to the web browser.

In another aspect of the invention any of the policies includes a policy enforcement action that requires performing any of data loss prevention (DLP) techniques, antivirus techniques, or antimalware techniques to the data.

In another aspect of the invention any of the policies includes a policy enforcement action that requires changing or otherwise manipulating the data prior to rendering the data or providing the data to the user.

In another aspect of the invention any of the policies includes a policy enforcement action that requires, prior to rendering the data or providing the data to the user, converting the data from a first format to at least second format that eliminates a portion of the data, and then converting the converted data to the first format.

In another aspect of the invention any of the policies includes a policy enforcement action that requires controlling client-side user interactions with a website.

In another aspect of the invention any of the policies includes a policy enforcement action that requires hiding a browser tab that is closed by the user and showing the hidden browser tab when the user next attempts to access a website or other content associated with the hidden browser tab.

In another aspect of the invention any of the policies includes a policy enforcement action that requires disabling a predefined application programming interface (API) of the web browser.

In another aspect of the invention any of the policies includes a policy enforcement action that requires any of disabling, hiding, or masking a predefined element of a webpage.

In another aspect of the invention the web browser further includes an auditor configured to record any actions attempted or performed by the user when using the web browser.

In another aspect of the invention the web browser further includes an auditor configured to record any actions attempted or performed by the web browser when the web browser is used by the user.

In another aspect of the invention the web browser further includes an auditor configured to record any network activity detectable by the web browser.

In another aspect of the invention the web browser is specifically configured to operate with one or more target applications.

In another aspect of the invention the policies are specifically adapted for use with the one or more target applications.

In another aspect of the invention any of the policies are defined and enforced using robotic process automation (RPA) techniques.

In another aspect of the invention the web browser is configured to implement multiple different profiles that are isolated from one another, each of the profiles has its own data including policies, cookies, cache, and local storage, and the different profiles are associated with any of different and concurrently-displayed browser tabs, different and concurrently-executing processes, and different and concurrently-executing browser instances.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of an enterprise browser system, constructed and operative in accordance with an embodiment of the invention;

FIG. 2 is a simplified flowchart illustration of an exemplary method of operation of the system of FIG. 1, operative in accordance with an embodiment of the invention;

FIGS. 3A-3L are simplified conceptual illustrations of exemplary policy configuration screens, constructed and operative in accordance with embodiments of the invention;

FIGS. 4A-4C are exemplary code snippets illustrating various methods used in implementing policies, constructed and operative in accordance with embodiments of the invention;

FIG. 5A is a simplified conceptual illustration of a method of cloud integration, constructed and operative in accordance with an embodiment of the invention;

FIG. 5B is a simplified flow diagram illustrating a method of browser login, constructed and operative in accordance with an embodiment of the invention;

FIG. 6 is a simplified flow diagram illustrating a method of establishing a private browsing session, constructed and operative in accordance with an embodiment of the invention;

FIG. 7A is a simplified flow diagram illustrating a method of defining and distributing policies, constructed and operative in accordance with an embodiment of the invention;

FIGS. 7B, 7C, and 7D are simplified examples illustrating the enforcement of a policy definition, constructed and operative in accordance with embodiments of the invention;

FIG. 8A is a simplified conceptual illustration of an exemplary auditor configuration screen, constructed and operative in accordance with an embodiment of the invention;

FIG. 8B is a simplified conceptual illustration of an exemplary auditing reporting system, constructed and operative in accordance with an embodiment of the invention;

FIG. 9A is a simplified flow diagram illustrating a method of enforcing use of a web browser by employing an identity provider, constructed and operative in accordance with an embodiment of the invention;

FIG. 9B is a simplified flow diagram illustrating a method of enforcing use of a web browser by employing a password vault, constructed and operative in accordance with an embodiment of the invention;

FIG. 9C is a simplified flowchart illustration of a method of enforcing use of a web browser by employing network tunneling, constructed and operative in accordance with an embodiment of the invention;

FIGS. 10A and 10B are exemplary code snippets illustrating various methods of extending web browser extension access, constructed and operative in accordance with embodiments of the invention;

FIG. 11 is an exemplary code snippet illustrating a method for configuring a proxy for use with embodiments of the invention;

FIG. 12A is a simplified flow diagram illustrating a method of using a web browser with a virtual private network (VPN), constructed and operative in accordance with an embodiment of the invention;

FIGS. 12B and 12C are simplified flow diagrams illustrating methods of using a web browser with a cloud connector, constructed and operative in accordance with embodiments of the invention; and

FIG. 13 is a simplified diagram illustrating isolation boundaries and multi-profile support, constructed and operative in accordance with an embodiment of the invention.

### DETAILED DESCRIPTION

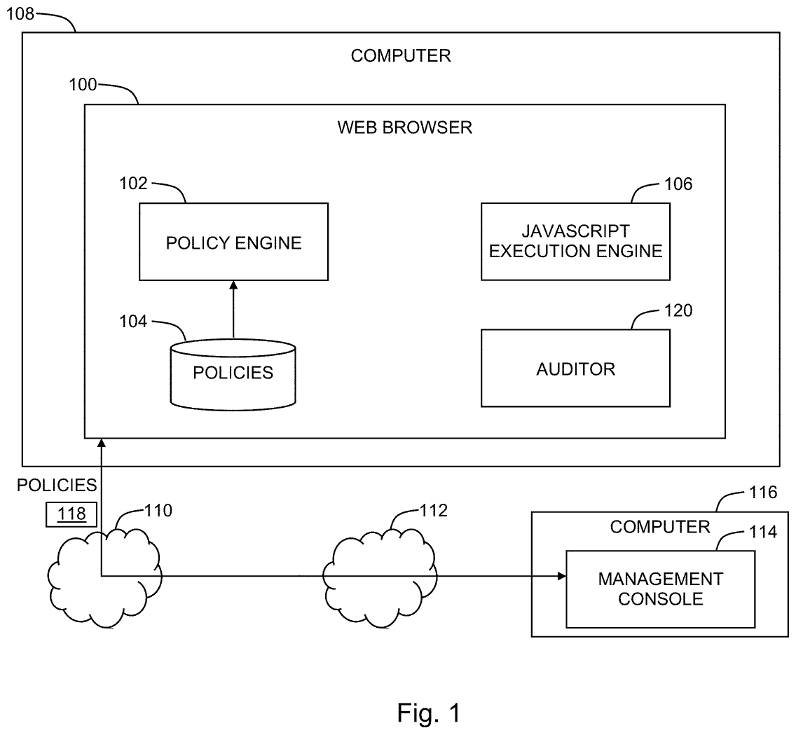

Reference is now made to FIG. 1, which is a simplified conceptual illustration of an enterprise browser system, constructed and operative in accordance with an embodiment of the invention. In FIG. 1 a web browser 100 is configured with a browser and rendering engine 101 that is configured to incorporate the functionality of conventional web browsers, such as those based on the Google™ Chromium™ architecture, such as sending and receiving data via computer networks and rendering data, such as webpages, except as and/or in addition to that which is otherwise described herein. Web browser 100 includes a policy engine 102 that is configured to implement policies 104 for controlling any aspect of web browser 100, such as, but not limited to, browser and rendering engine 101, its user interface, JavaScript™ interpreter, extensions, networking configuration, and data persistence. For example, policy engine 102 may be configured to implement policies 104 by enabling or disabling extensions, controlling extension permissions, controlling local client cache and cookies, controlling user behavior such as copy, paste, printing, saving files, and taking a screenshot, as well as controlling communications between web browser 100 and any devices, such as peripheral devices, that are accessible to a computer that hosts web browser 100. Policies 104 are configured to relate to various types of information, such as, but not limited to, device posture as it relates to computing devices that host web browser 100 or otherwise interact with web browser 100; identification information of computer users that interact with web browser 100; webpages and other data that are accessed by or provided by web browser 100; networking information, both at the local computer network of web browser 100, as well as at external computer network locations that are accessible to web browser 100; and computer user behavior when using web browser 100. For example, policies 104 may be configured to depend on the presence, absence, or status of antivirus software or other types of software or operating system processes, specific registry data, and certificates on computing devices that host web browser 100, as well as whether the network access of web browser 100 is via mobile, WIFI, or wired connection, and from what network domain or address.

Web browser 100 is configured to provide to policy engine 102 any information that is required to evaluate policies 104. Some examples of such information required to evaluate policies 104, and actions that may be taken by policy engine 102 to implement policies 104, include the following. In one example, policy engine 102 disables a specific browser application programming interface (API), such as to defend the API against a known exploit, when web browser 100 accesses websites that have a reputation score below a predefined minimum score, where such reputation scores may be determined in accordance with conventional techniques. In another example, policy engine 102 censors specific content on a retrieved webpage, such as by applying a predefined regular expression to the Document Object Model (DOM) of the webpage to find Personally Identifiable Information (PII) which policy engine 102 then hides or masks. In another example, policy engine 102 reports specific events to an analytical database or a Security Operations Center (SOC), such as when a user performs a “share document” action in Google™ Docs™, and may do so even if Google™ Docs™ doesn't provide an application programming interface (API) for the action where web browser 100 is configured to monitor use of any user interface share functionality. In another example, web browser 100 is configured to monitor a code execution engine 106 that is integrated into web browser 100 for executing JavaScript™ code or any other software instructions, where policy engine 102 reports outlier behaviors specified by policies 104, such as poor performance characteristics and buffer overrun attempts. In another example, web browser 100 is configured to detect specific types of upload or download events that policy engine 102 reports in accordance with policies 104.

Web browser 100 may be hosted by any computing device, such as by a computer 108 that is connected to a computer network 110, which may be a corporate intranet that provides access to one or more other networks 112, such as the Internet. Copies of web browser 100 may, for example, be installed on multiple computing devices for use by individuals associated with an organization, such as by employees or contractors of a company, on company-owned computing devices or on non-company-owned computing devices, and configured to operate as described herein by system administrators and/or other parties authorized by the organization in order to enforce policies set by the organization.

Web browser 100 is preferably configured to require that each user of web browser 100 be authenticated before web browser 100 is allowed to perform one or more predefined operations, such as each time web browser 100 is executed and/or periodically thereafter, such as at predefined time intervals and/or before web browser 100 performs one or more operations predefined as requiring user reauthentication. Web browser 100 is also preferably configured to validate one or more signed and/or encrypted policies 104 before web browser 100 is allowed to perform one or more predefined operations.

A management console 114 is provided for use by system administrators and/or other authorized parties to define policies 104 and provide policies 104 to web browser 100. Management console 114 may be hosted by any computing device, such as by a computer 116 that is in communication with web browser 100 either directly via computer network 110 or indirectly via network 112.

In one embodiment of the invention, one or more instances of web browser 100 are specifically configured to operate with one or more target applications, such as WhatsApp™, Salesforce™, or other applications. Such configuration my be done via management console 114 by providing a target application Uniform Resource Locator (URL), an icon, and an executable file name for the specially-configured web browser 100, where management console 114 provides, in accordance with conventional techniques, an installation file 118 that includes the specially-configured web browser 100 and the above elements above, where installation file 118 is then deployed and installed on a computing device in accordance with conventional techniques. In this embodiment each specifically-configured web browser 100 includes all the capabilities of web browser 100 described herein, but may have user interface elements that are specifically adapted for use with its target application(s), and/or may limit access to specific target application features, such as by blocking file sharing where web browser 100 is specifically configured to operate with WhatsApp™, and/or may have policies that are specifically adapted for use with the target application(s).

In one embodiment of the invention, web browser 100 includes an auditor 120 configured to record and/or report specific data and/or metadata relating to users, websites, applications, networking, JavaScript™ and API usage, HTML and DOM information, and policy-related information and enforcement activity, as is described in greater detail hereinbelow.

Web browser 100 is preferably configured as an executable file that is created, in accordance with conventional techniques, by compiling computer software instructions that implement any of the features and functionality of web browser 100 described herein, including any of the features and functionality of conventional web browsers and anything else described herein with which web browser 100 is configured, such as, but not limited to, policy engine 102, policies 104, and auditor 120.

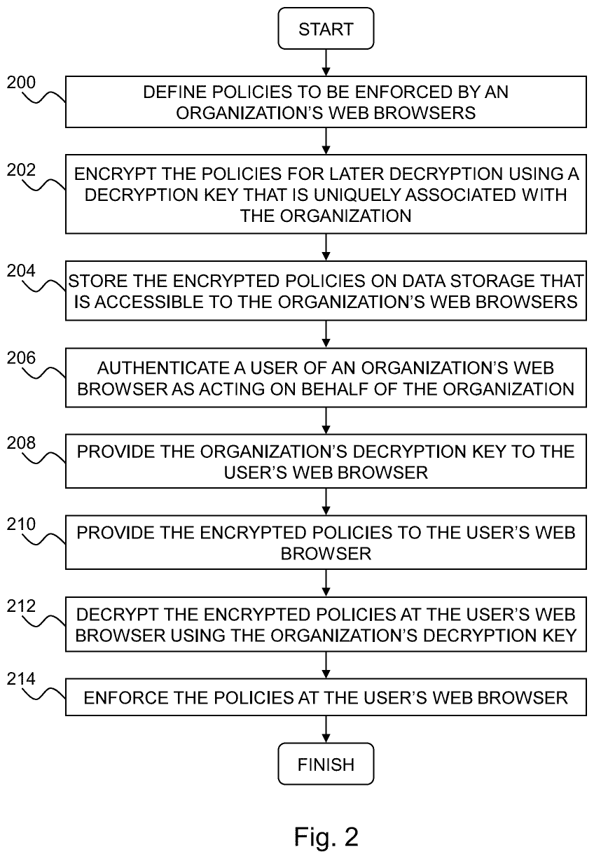

Reference is now made to FIG. 2, which is a simplified flowchart illustration of an exemplary method of operation of the system of FIG. 1, operative in accordance with an embodiment of the invention. In the method of FIG. 2, a system administrator for an organization uses a management console, such as management console 114 of FIG. 1, to define one or more policies for controlling web browsers, such as web browser 100 of FIG. 1, that are provided by the organization for use on its behalf, such as by the organization's employees or contractors (step 200). The policies are then encrypted for later decryption using a decryption key that is uniquely associated with the organization (step 202). The encrypted policies are stored on one or more data storage devices that are accessible to the organization's web browsers, such as by providing the policies to a cloud-based storage service (step 204). After a user of the web browser is authenticated and identified as acting on behalf of the organization (step 206), the user's web browser receives the organization's decryption key (step 208). The user's web browser receives the encrypted policies from their storage location (step 210), decrypts them using the organization's decryption key (step 212), and enforces the policies (step 214).

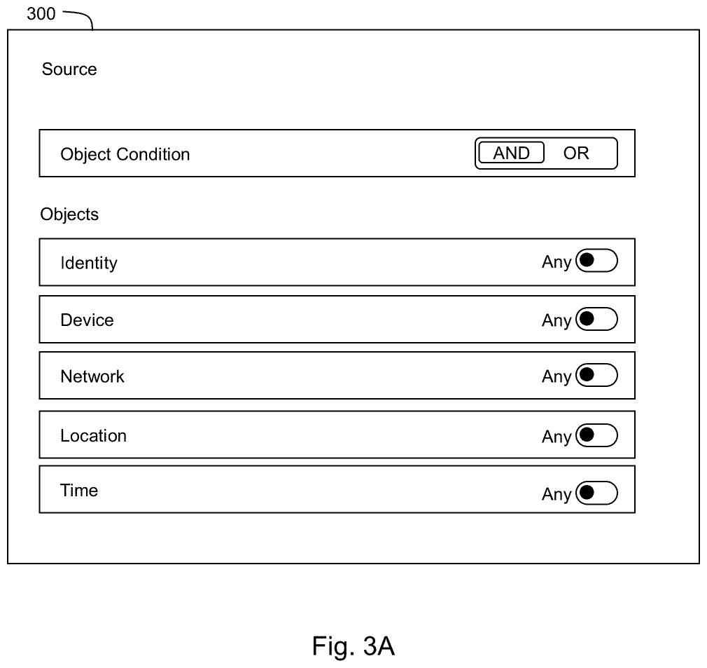

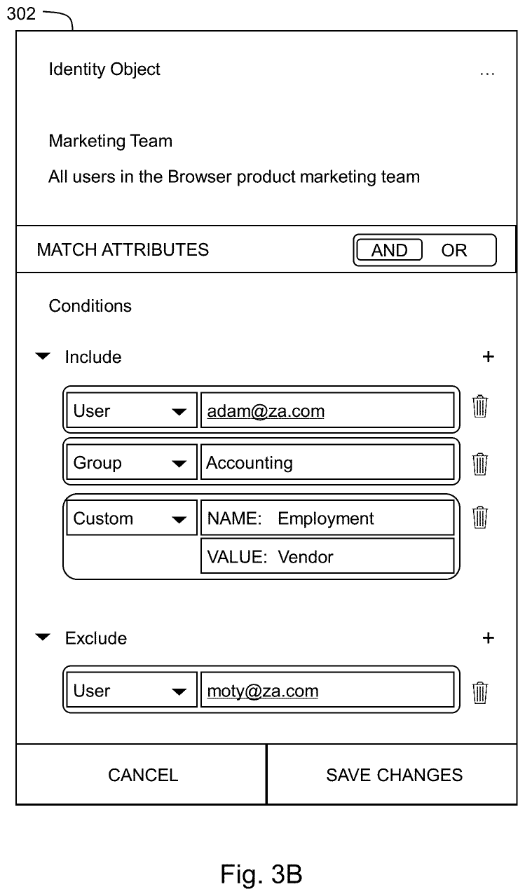

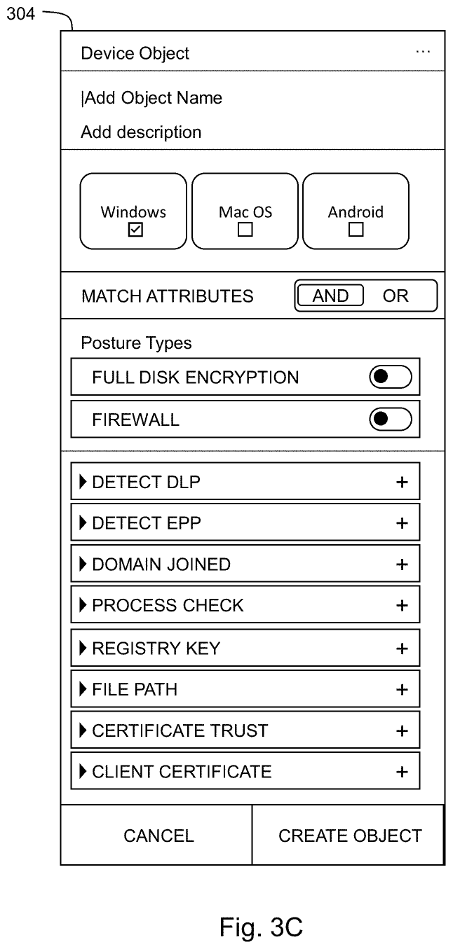

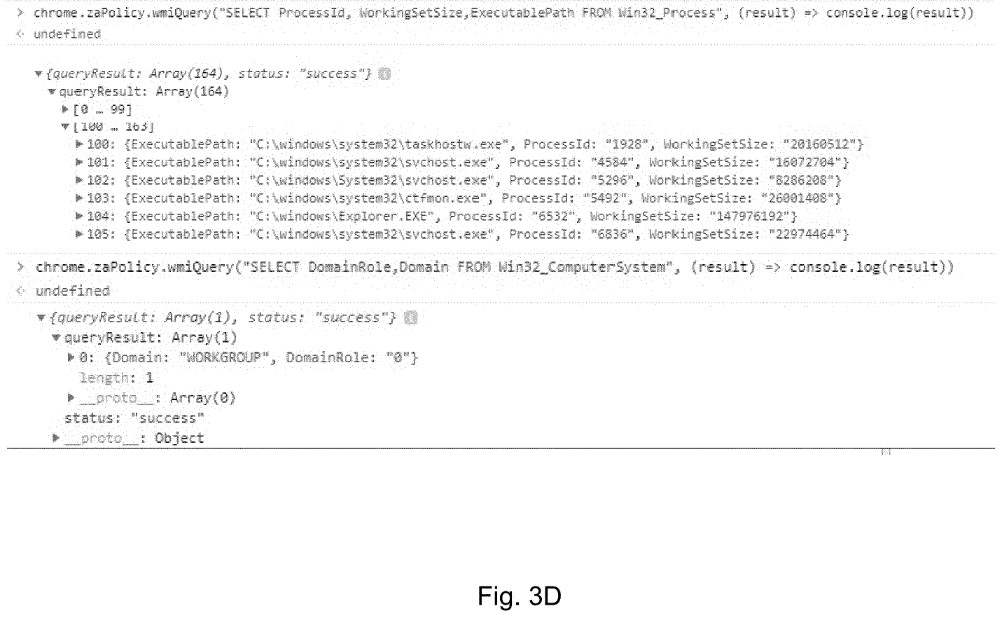

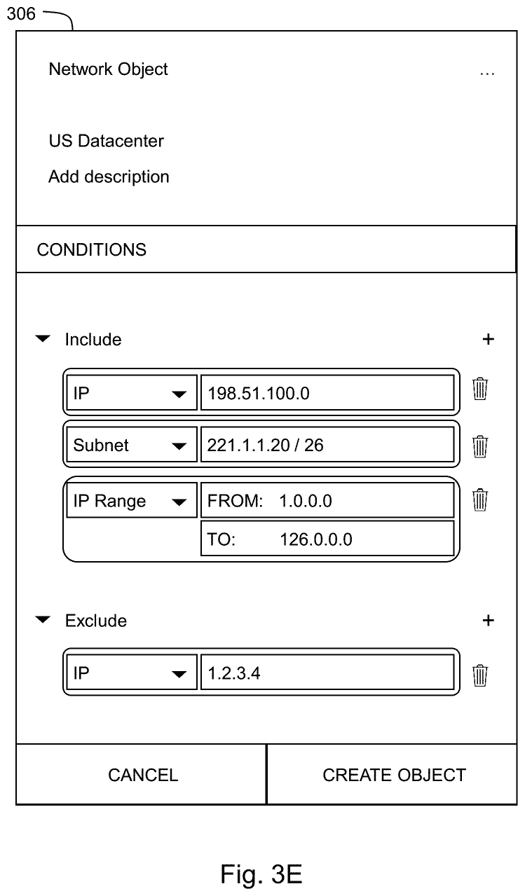

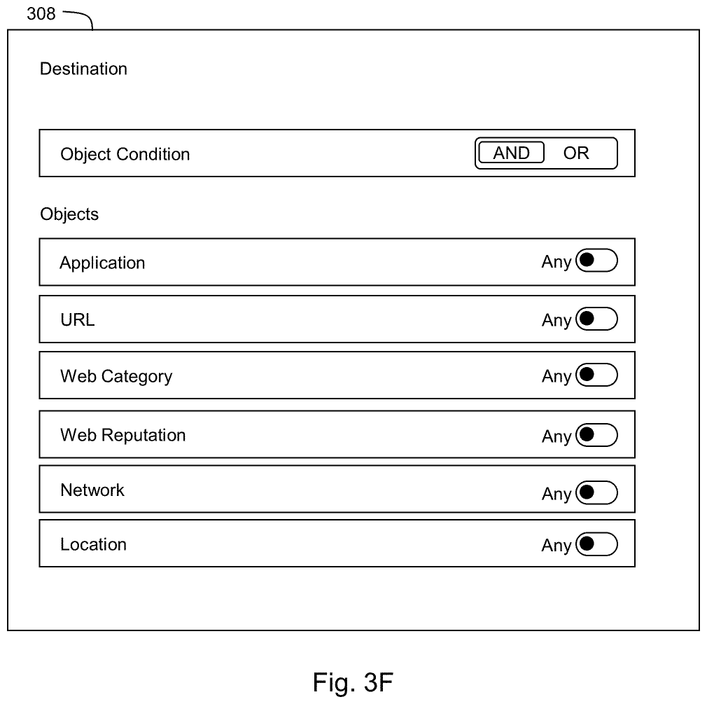

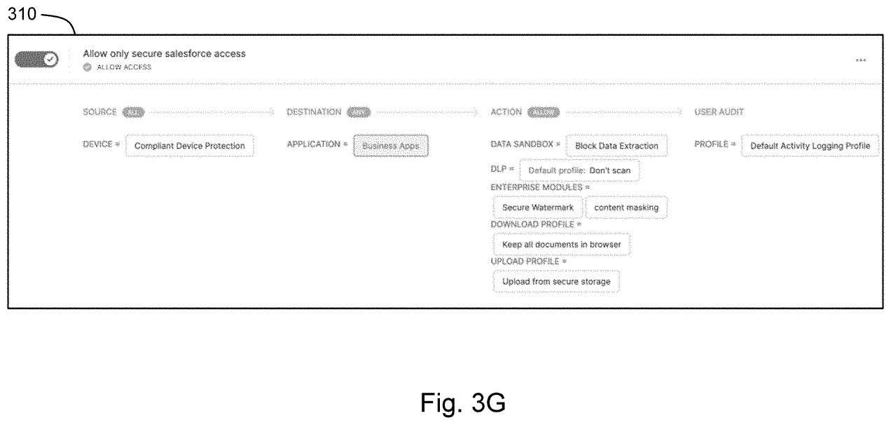

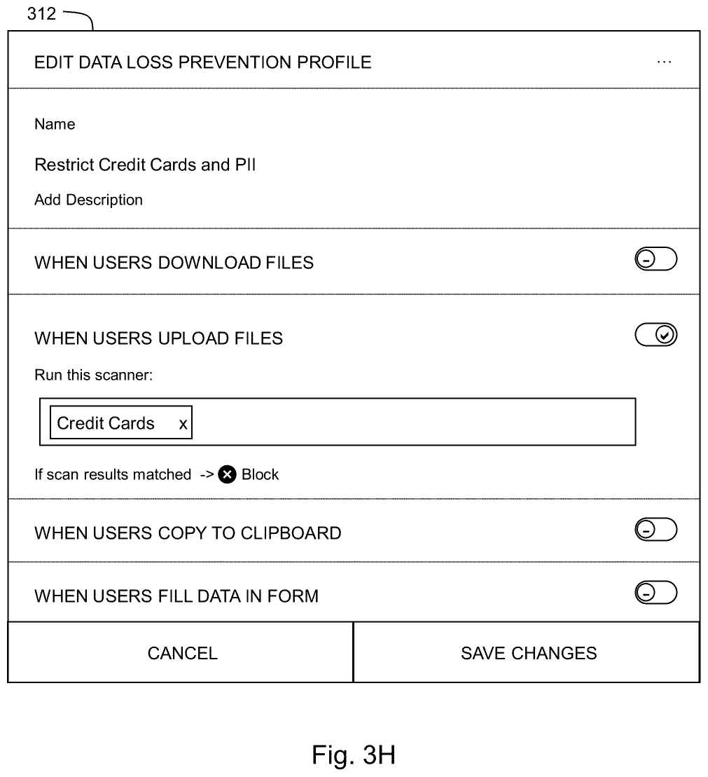

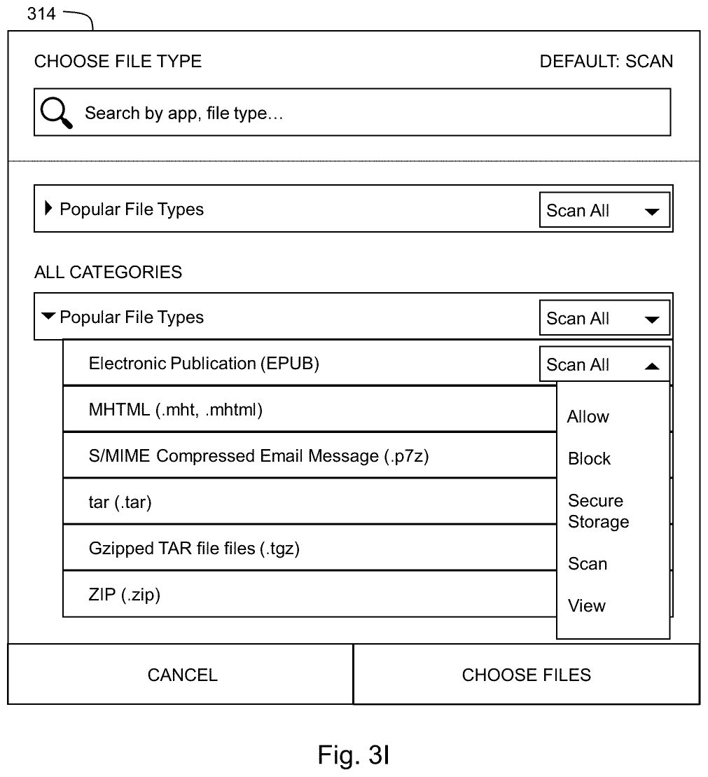

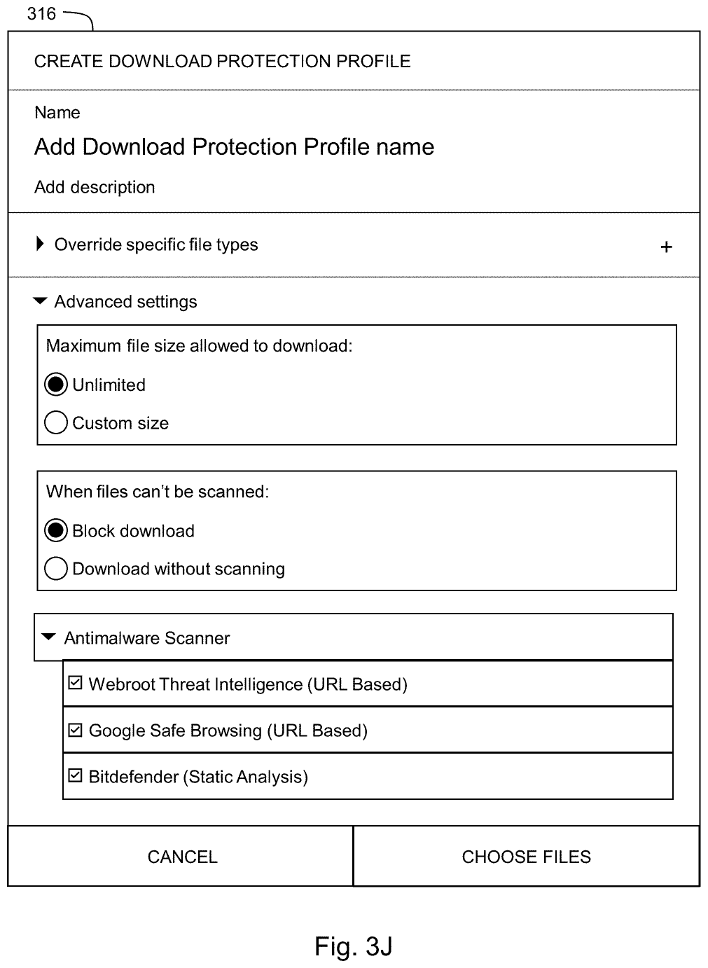

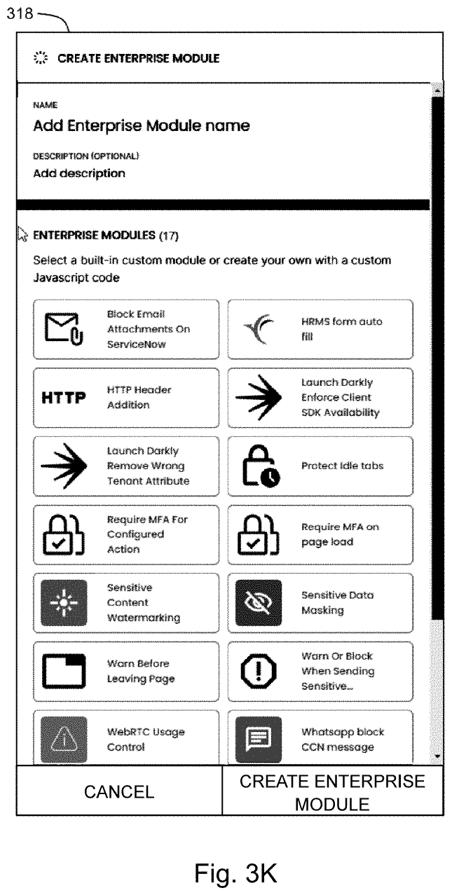

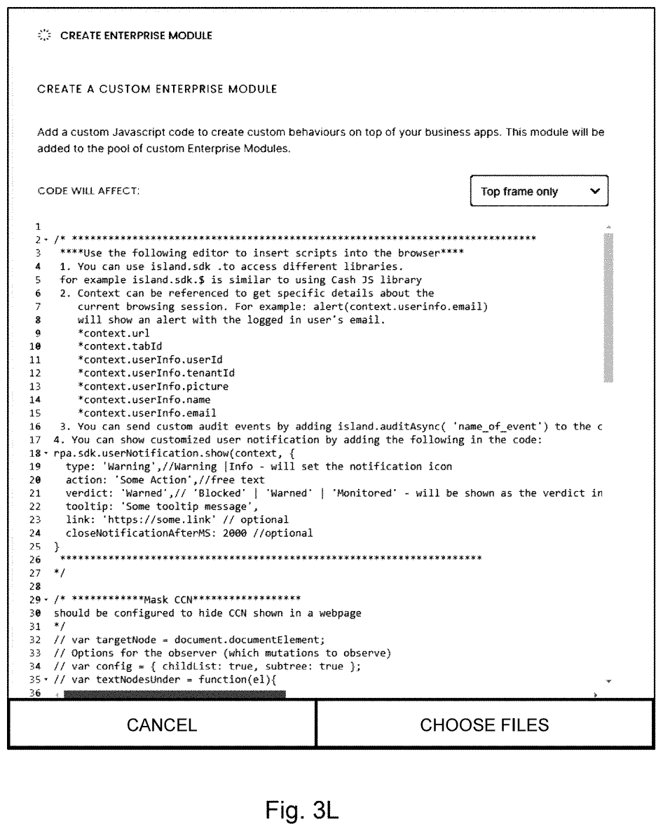

Reference is now made to FIGS. 3A-3L, which are simplified conceptual illustrations of exemplary policy configuration screens, such as may be provided by management console 114 for defining policies 104 of FIG. 1, constructed and operative in accordance with embodiments of the invention, where policies 104 include policy conditions and associated policy enforcement actions that are carried out when the associated policy conditions are met. In FIG. 3A a screen 300 shows various types of information that may be specified for policy conditions associated with policies 104 and that are based on the source location of web browser 100, such as identity information associated with users of web browser 100, information associated with the configuration or other characteristics of the computing device that hosts web browser 100, information about the computer networks that are accessible to web browser 100, the current geographical location of web browser 100, and the current date and time at web browser 100. In FIG. 3B a subsidiary screen 302 of screen 300 is shown in which required identity-related information may be specified for policies 104, such as by specifying user information, group information, role information, and custom information requirements, including any identity-related information that may be determined in accordance with conventional techniques, such as using a Security Assertion Markup Language (SAML) query. In FIG. 3C a subsidiary screen 304 of screen 300 is shown in which in which required device information may be specified for policies 104, such as by specifying the type of operating system that hosts web browser 100 and any other device-related information that may be determined in accordance with conventional techniques, such as using a Windows Management Instrumentation (WMI) query. An example showing how to expose the WMI query surface to an extension is shown in FIG. 3D. In FIG. 3E a subsidiary screen 306 of screen 300 is shown in which in which required network information may be specified for policies 104, such as by specifying valid and invalid IP address information, WiFi type, and any other network-related information that may be determined in accordance with conventional techniques.

In FIG. 3F a screen 308 shows various types of information that may be specified for policies 104 and that are associated with the destination of information and queries sent by web browser 100, such as information regarding applications with which web browser 100 communicates and URLs accessed by web browser 100, as well as website category information, website reputation information, network information, and location information, any of which information may be determined in accordance with conventional techniques. Examples of such information include any of the name, IP address, and URL of one or more destinations, including by specifying URL patterns using regular expressions and wildcards. URL context information may also be specified. For example, where policies 104 are configured to allow web browser 100 to access to salesforce.com while blocking access to unknown URLs or IP addresses, policies 104 may be configured to allow web browser 100 to access an unknown destination to which it is redirected by salesforce.com. Another URL context may be defined where the first URL accessed in a browser tab was not entered by the user using a keyboard, such as when the user clicks on a link in an email in an external email application, whereupon anti-phishing measures may be taken. Examples of destination website categories may include “Business”, “Bandwidth consumption”, “Risky”, “Unknown”, “Personal/Private”, “Social Networks”, and “Legal Liability.” Management console 114 may be used to define destination IP addresses and ranges of addresses, website URLs, regular expressions, selection of Software as a Service (SaaS) applications, and categories of websites, or may refer web browser 100 to backend services providing threat intelligence and third-party website category providers such as WebRoot™, Cyren™ or Google™ Risk API, where website categories may be defined at the full URL level, at the domain name level, or any level in between. Website reputation may be determined by querying a third-party website reputation provider or by applying predefined heuristics that analyze behavior of the website in accordance with conventional techniques. Examples of destination network information include its IP address and subnet.

In FIG. 3G a screen 310 is shown for associating source and destination information representing policy conditions of a policy to policy enforcement actions that are to be performed when the specified policy conditions are met, as well as to an auditing profile that defines auditing actions that are to be performed in connection with the defined policy. In FIG. 3H a screen 312 is shown for defining a data loss prevention (DLP) profile indicating a policy enforcement action to be performed when a file upload is performed, where the file is scanned for credit card numbers and the upload is blocked if any credit card numbers are found in the file. In FIG. 3I a screen 314 is shown for defining a policy enforcement action to be performed when a file upload or a file download is performed based on the file's type. In FIG. 3J a screen 316 is shown for defining a file download protection profile indicating policy enforcement actions to be performed when a file download is performed in which multiple types of antimalware scans are to be performed on the downloaded file.

In one embodiment policy conditions and enforcement actions are defined using conventional Robotic Process Automation (RPA) techniques. In one embodiment policy conditions and enforcement actions are acquired from third-party vendors in the form of RPA modules and optionally modified using management console 114 (FIG. 1), where RPA modules include policy conditions, policy enforcement actions, or both. In FIG. 3K a screen 318 is shown listing various types of RPA modules for selection. In one embodiment policy conditions and/or enforcement actions are defined using a scripting language, such as JavaScript™, an example of which is shown in FIG. 3L.

In addition to the types of information described above that may be used to define policy conditions (e.g., device posture, identity, URL category, networking information, computer user behavior), some examples of such policy conditions include:
A given result of a JavaScript™ function;
The detection of a data download or upload event;
The source of a URL provided to the web browser (e.g., typing the URL into the browser address bar, selecting the URL from a bookmark, clicking on a link in an external application, a redirection from an accessed webpage);

Some examples of policy enforcement actions include:
Masking specific content on a given website (e.g., Mask PII when accessing salesforce.com);
Disabling screenshot functionality of the current website if it provides predefined types of confidential data;
Blocking access to the “Share” button in Microsoft PowerPoint™ on office365.com;
Adding a watermark of the current user name in a certain webpage (e.g., gmail.com) or on a given document;
Adding a red border when accessing a website that meets predefined security criteria (e.g., has predefined characteristics associated with suspicious websites);
Blocking message forwarding capabilities of web.whataspp.com;
Masking credit card numbers while providing an “unmask” button that allows masked information to be displayed;
Redirecting outbound HTTP requests to an intermediate proxy service that controls how and what is returned from the intended recipients of the HTTP requests;
Lowering connection speed, such as by requesting lower-quality content from a video stream;
Changing the security permissions of the current browser session or a specific browser tab, such as by launching a specific browser process with low OS permissions when accessing an unknown website;
Automatically locking certain websites with a protection screen requiring additional authentication that is not required by the website, and/or doing so when entering or leaving specific browser tabs;
Automatically loading certain websites, such as an enterprise email website, when the browser is run;
Hiding, rather than closing, browser tabs that are closed by the user, and showing hidden tabs when the user next attempts to access their associated websites or other associated content.

Policies may be defined and applied to protect sensitive data, such as may be triggered by detecting attempts to submit data to websites via HTML forms, upon detecting attempts to copy, cut, paste, save, or print data, upon detecting specific webpage elements, or upon accessing specific websites. Sensitive data may be identified using a predefined list of data types and formats, such as credit card number formats or Social Security Number formats, or by using predefined regular expressions. Identified sensitive data may then be protected in accordance with conventional techniques, such as by masking, redacting, or hiding the sensitive data. The protection of sensitive data may be performed by the web browser, a web browser extension or RPA module, or on a remote computer.

Policies may be defined and applied when attempts to upload or download files or other data are detected. In one example, the download or upload attempt may be allowed without taking any action. In another example, the download or upload attempt may be blocked and a message displayed indicating that the download or upload attempt was blocked. In another example, one or more known types of scanning of the subject files may be performed, such as scanning to detect malware and prevent exposure of sensitive data, and one or more known types of post-scanning actions may be performed when related conditions are met, such as file quarantine, with the file stored either locally or at a remote location, file deletion, and the like. The scanning may be performed by the web browser, a browser extension or RPA module, or on a remote computer. If the file is encrypted, a visual prompt may be provided to allow a user to enter a decryption key or password so that the file may be decrypted before it is scanned. In an embodiment, policies relating to attempts to upload or download files or other data are, if possible, evaluated partly or wholly in parallel to performing the upload or download. For example, while a webpage is being retrieved, retrieved portions of the webpage, such as HTML, JavaScript™ code, stylesheets, etc., may be provided to browser and rendering engine 101 (FIG. 1) while policy engine 102 evaluates the policy conditions of a policy that is associated with the webpage retrieval to determine if the webpage or any of its elements should be blocked or modified before browser and rendering engine 101 displays the rendered webpage.

Policies may be defined to control where and how downloaded files are stored. For example, downloaded files may be stored on the local file system or at a predefined remote location. Downloaded files may be encrypted before they are stored using any know encryption technique, such as based on the identity of the downloading user, thus preventing other users of the same web browser from decrypting the file. Downloaded files may undergo one or more conversions to other file formats, such as from JPEG to PNG and back to JPEG to remove potentially malicious portions before the files are rendered or otherwise provided to the user.

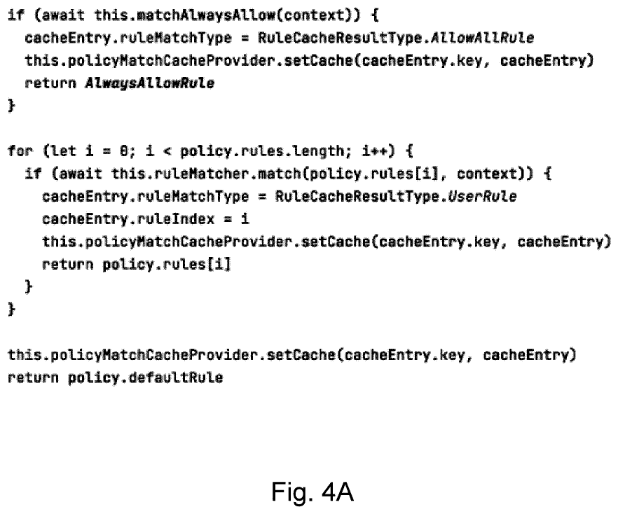

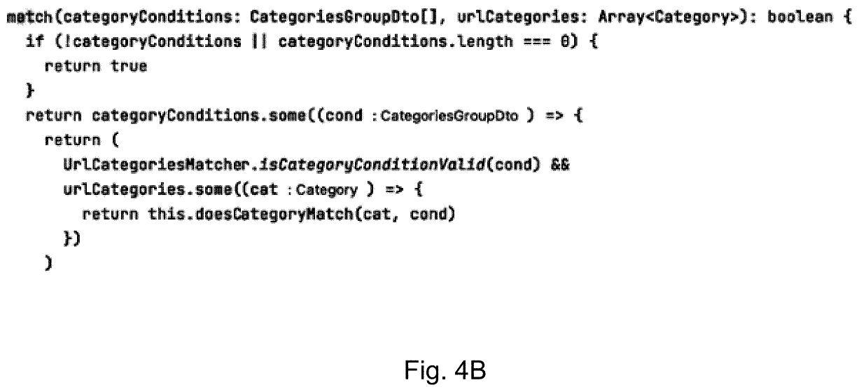

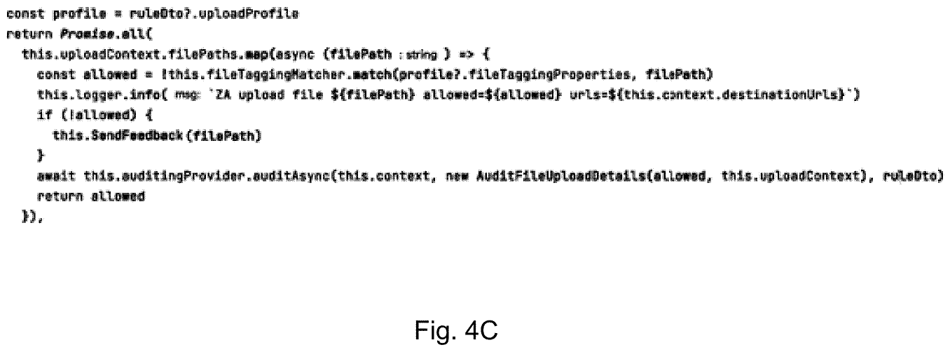

Reference is now made to FIGS. 4A-4C, which are exemplary code snippets illustrating various methods used in implementing policies, such as may be employed by policy engine 102 to enforce policies 104 of FIG. 1, constructed and operative in accordance with embodiments of the invention. FIG. 4A shows a code snippet illustrating a policy matching operation with rules, matchers, and built in cache, where the code accepts a policy object and a browser context object that provides current browser context information. The browser context object is preferably configured with fields and values providing information related to the current browser context, such as indicating the top-level URL of the currently-accessed website (e.g. Dropbox.com), the current URL of the request (e.g., CDN.Internal.Dropbox.com), the user identity, the tab id of the associated browser tab, the browser version, the source IP address of the request, device information, identity information, etc. FIG. 4B shows a code snippet illustrating website category matching. FIG. 4C shows a code snippet illustrating an upload profile which relates to a policy that is to be applied to uploaded files, such as by scanning them for malware or performing data loss prevention (DLP) techniques on them.

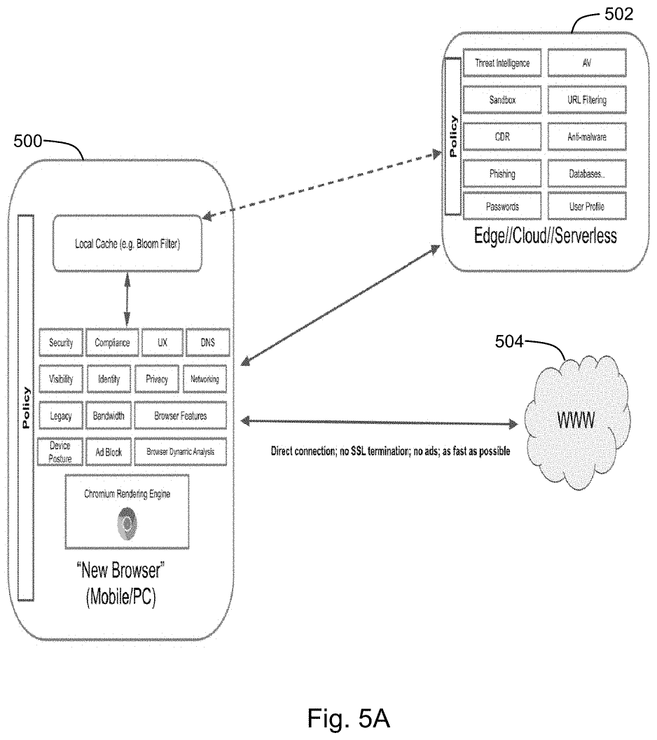

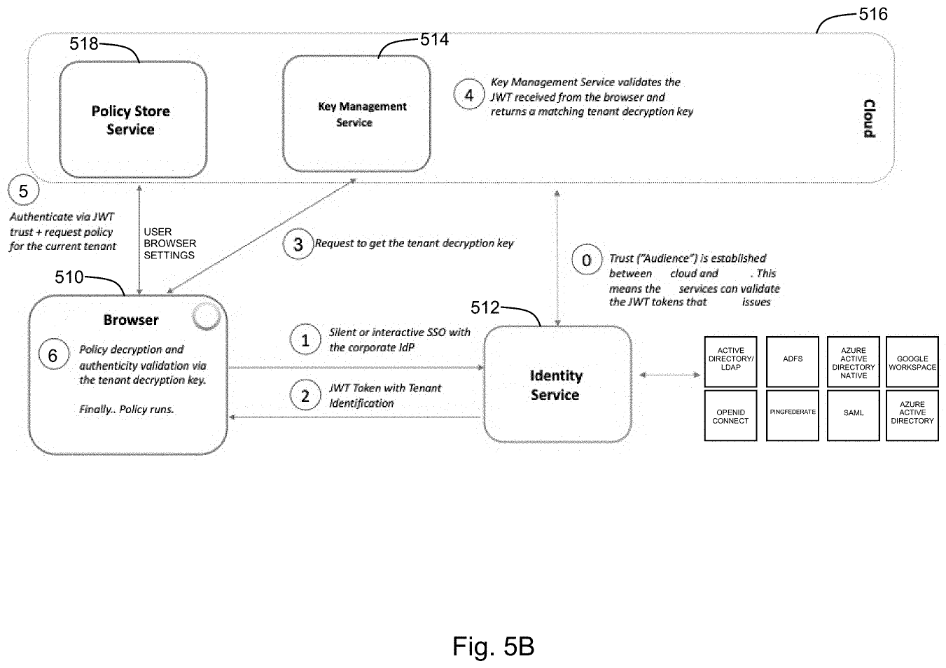

Reference is now made to FIG. 5A, which is a simplified conceptual illustration of a method of cloud integration, constructed and operative in accordance with an embodiment of the invention. In FIG. 5A, a web browser 500, such as may be hosted by a computing device such as a mobile telephone, is configured as described hereinabove with reference to web browser 100 of FIG. 1, but where the policy enforcement functionality of policy engine 102 to enforce policies 104 is carried out both by web browser 500 and by a computer server 502, such as a cloud-based server, that is in communication with web browser 500 via a computer network 504, such as the Internet. If a network request to the cloud is required to execute a policy (e.g., to classify a URL) it may be implemented either synchronously (e.g., as a blocking HTTP call), asynchronously (e.g., as a non-blocking HTTP call that allows the normal flow of web browser 500 to continue running with a callback applying the policy result once that is returned), or via a websocket protocol.

Reference is now made to FIG. 5B, which is a simplified flow diagram illustrating a method of browser login, constructed and operative in accordance with an embodiment of the invention. In FIG. 5B, a web browser 510, such as is configured as described hereinabove with reference to web browser 100 of FIG. 1, initiates a silent or interactive single sign-on (SSO) with an identity provider (IdP) 512 at step #1, where IdP 512 is configured to provide user authentication services for users of web browser 510. During step #1 user credentials, such as a user login name, that are known to IdP 512 are provided to IdP 512. At step #2, after authenticating the user credentials, IdP 512 provides a JSON Web Token (JWT) to web browser 510, where the JWT includes information identifying an IdP tenant that is known to IdP 512 as being associated with the provided user credentials, such as where the tenant is a company or other organization with which the user is associated. At step #3 web browser 510 sends the JWT to a cloud server 516, which validates the JWT and identifies the user and the tenant, and requests a decryption key that is uniquely associated with the tenant, such as from a key management service 514 hosted by cloud server 516. At step #4, after the JWT has been validated and the tenant and user identified, key management service 514 provides the tenant decryption key to web browser 510. At step #5 web browser 510 asks a policy store service 518 for policies that are defined for, and preferably encrypted for, the tenant. At step #6 web browser 510 decrypts encrypted policies using the decryption key for enforcement. In one embodiment, cloud server 516 stores browser settings associated with the authenticated user, such as, but not limited to, passwords, credit cards, user profile settings, and bookmarks, and provides them to web browser 510, preferably in encrypted form for decryption by web browser 510 using the tenant decryption key.

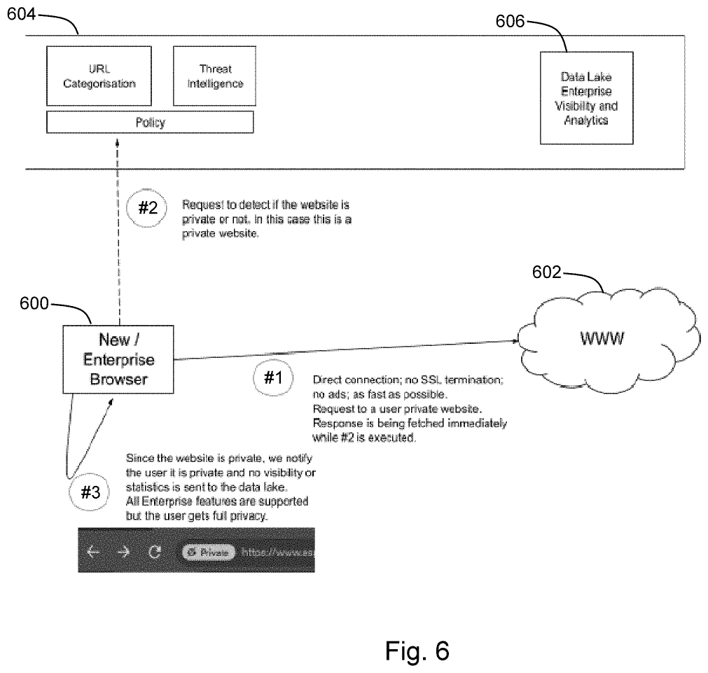

Reference is now made to FIG. 6, which is a simplified flow diagram illustrating a method of establishing a private browsing session, constructed and operative in accordance with an embodiment of the invention. FIG. 6 shows a URL filtering policy being enforced in a non-blocking fashion. At step #1, a web browser 600, configured as described hereinabove with reference to web browser 100 of FIG. 1, attempts to access a website via a computer network 602, such as the Internet. At step #2, while web browser 600 receives a response from the website, web browser 600 instructs a policy engine 604, configured as described hereinabove with reference to policy engine 102 of FIG. 1, to determine whether a policy exists that indicates that a private browsing session is to be established for the accessed website, such as, for example:
If the category of the web site is categorized as “personal email” or “healthcare provider”;
If the website is not a business-related website, where such information is provided by a third-party website category provider or in a pre-defined list of all of the websites and applications that are used by an organization that provides policies that are to be enforced by web browser 600;
Websites whose IP addresses are not associated with the organization;
Web sites that are accessed by devices that do not belong to the organization;
A private indicator is basically an audit verdict that can be apply to any rule combination suggested.

Any policy may be marked with an indicator that indicates that a private browsing session is to be established if the policy's conditions are met. At step #3, after policy engine 604 determines that the accessed website is a private website, web browser 600 displays a visual indication that the accessed website is a private website, displays information retrieved from the private website, and applies any security controls indicated by policy engine 602, but without storing any information relating to accessing or interacting with the private website, such as in a data lake 606.

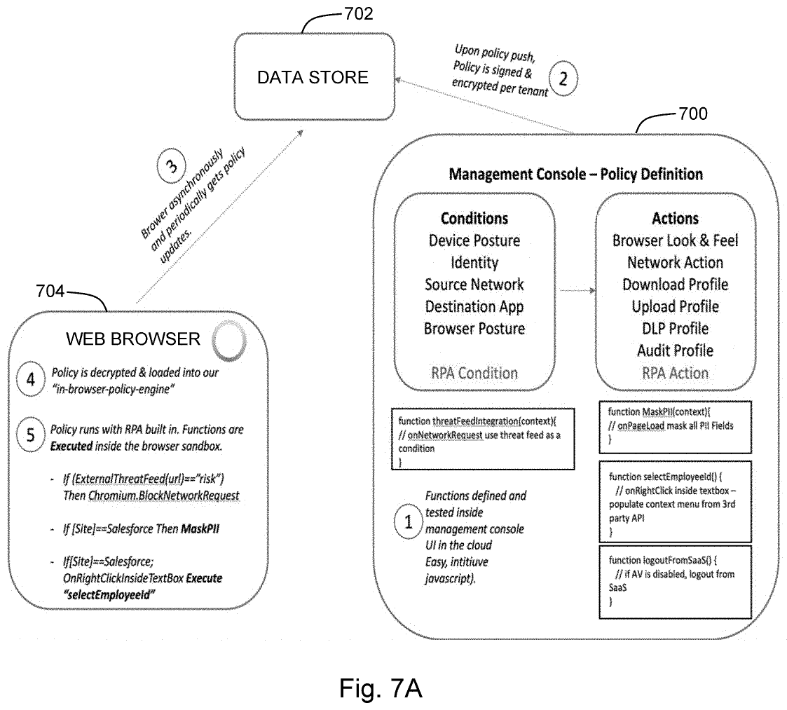

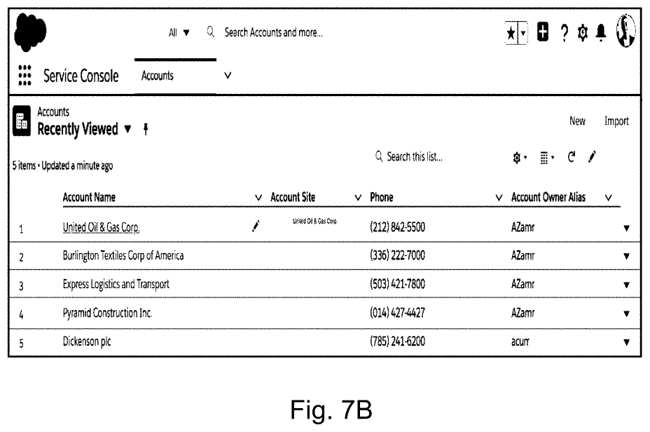

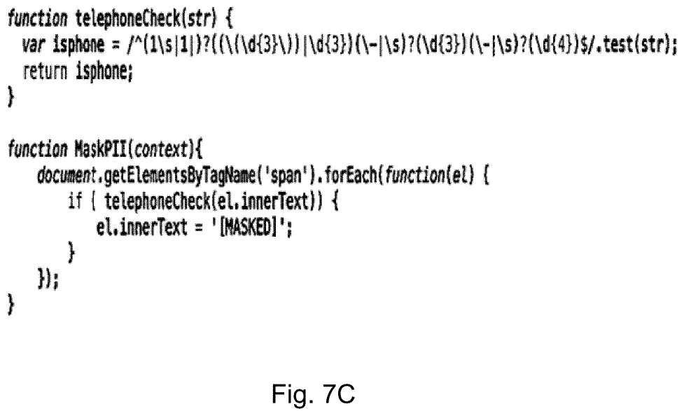

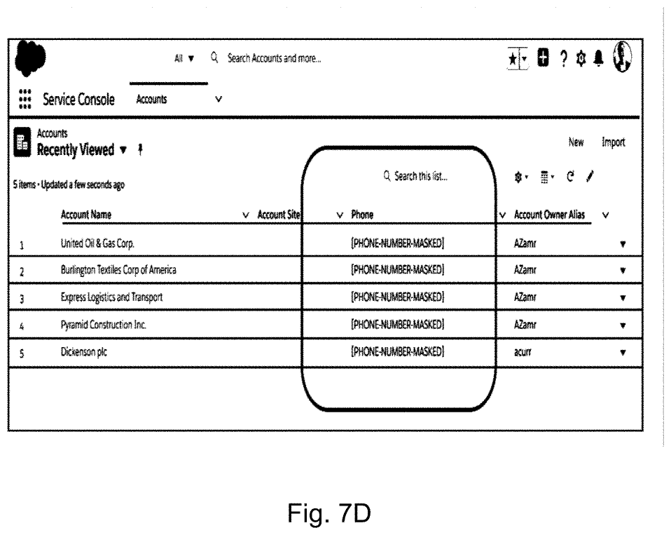

Reference is now made to FIG. 7A, which is a simplified flow diagram illustrating a method of defining and distributing policies, such as policies 104 of FIG. 1, constructed and operative in accordance with an embodiment of the invention. At step #1, a management console 700 is used, such as by an authorized system administrator, to define various policies, including policy conditions that are to be evaluated, and policy enforcement actions that are to be taken if the policy conditions are met, such as by policy engine 102 of FIG. 1. The policies may be defined using the screens described above with reference to FIGS. 3A-3L. In one embodiment management console 700 encrypts and signs policy definitions in a specific manner, such as specific to a given installation of a web browser 704 or to a specific identity, such as an organization and individuals associated with the organization, where web browser 704 is configured as described hereinabove with reference to web browser 100 of FIG. 1. At step #2, management console 700 provides the policy definitions to a data store 702 that is accessible, such as via a computer network, to web browser 704. At step #3 web browser 704 periodically and asynchronously retrieves the policy definitions that are applicable to it from data store 702. At step #4 the retrieved policy definitions are decrypted and made available to a policy engine of web browser 704 that is configured as described hereinabove with reference to policy engine 102 of FIG. 1. At step #5 the retrieved policy definitions are checked and enforced.

An example illustrating the enforcement of a policy definition is shown with additional reference to FIGS. 7B-7D. In FIG. 7B a webpage retrieved by web browser 704 shows telephone numbers. Before the webpage is displayed by web browser 704, the policy definition shown in FIG. 7C is evaluated and enforced, whereupon web browser 704 displays the webpage with masked telephone numbers as shown in FIG. 7D.

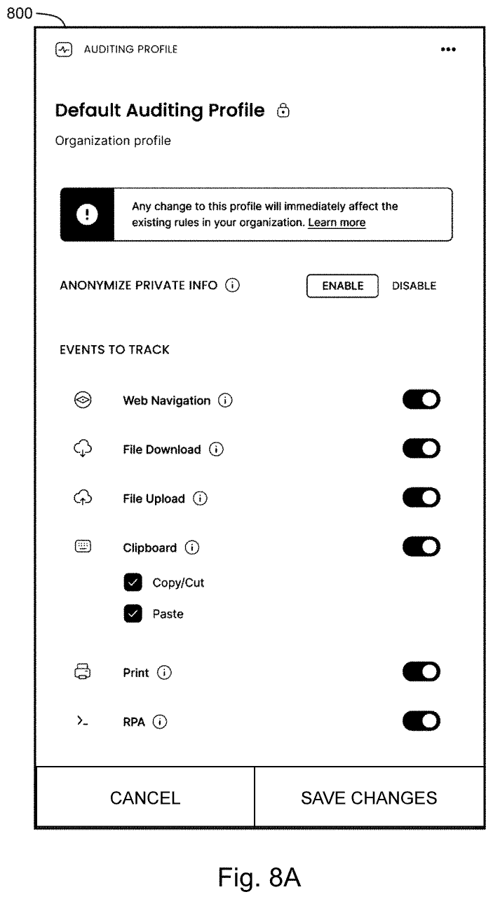

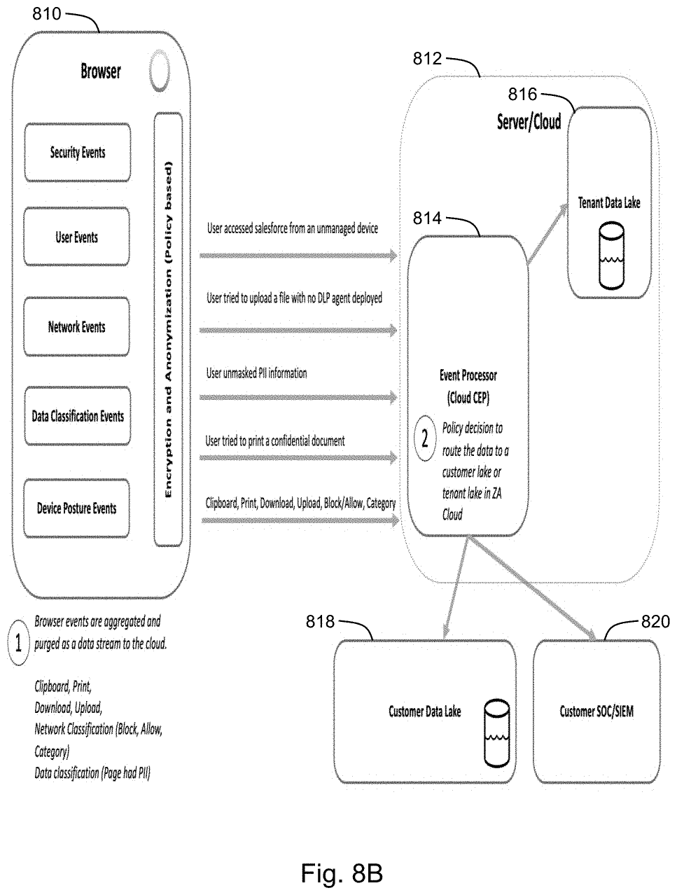

Reference is now made to FIG. 8A, which is a simplified conceptual illustration of an exemplary auditor configuration screen, such as may be provided by management console 114 for configuring auditor 120 of FIG. 1, constructed and operative in accordance with an embodiment of the invention. In FIG. 8A a screen 800 shows various types of information that may be specified for auditing, such as web navigation events, file download events, file upload events, clipboard events such as copy/cut and paste, printing events, and running RPA automated tasks. More detailed examples regarding which data and/or metadata may be specified for recording during auditing include:
Network traffic, such as, for example, HTTP requests and responses;
User activities, such as, for example, mouse input, keystroke input, scrolling, copy, paste, screenshots, activating extensions, printing, saving a file; navigation, including navigation that involves opening a new tab, such as when a user clicks on a link in an application outside of the web browser, such as on a link in an email; and redirection;
Policy conditions that are met;
Policy enforcement actions that are performed;
JavaScript™ and API calls, such as, for example, the usage of Web Audio API in JavaScript™;
HTML and DOM-level data, such as, for example, the presence of PII data, hidden HTML elements, and password fields;
RPA modules that are run and/or specific actions that occur when running an RPA module, such as, for example, an RPA module for use with salesforce.com that masks all PII fields and allows users to unmask PII fields, where user-initiated unmasking operations are specified for auditing;
Sharing, viewing, and/or using log files and/or log file content;
Periodic screenshots or other recordings of browser activity.

Screen 800 may be used to specify that private information be anonymized when auditing events.

Additionally or alternatively, auditing may be implemented via policy definition as described hereinabove, where specified auditing actions are performed or prevented based on meeting specified policy conditions. For example, auditing of events that are related to private websites may be prevented via policy definition.

Reference is now made to FIG. 8B, which is a simplified conceptual illustration of an exemplary auditing reporting system, constructed and operative in accordance with an embodiment of the invention. FIG. 8B shows a web browser 810, configured as described hereinabove with reference to web browser 100 of FIG. 1 and the auditing features described hereinabove with reference to FIG. 8A, in which audited information is sent by web browser 810 to a computer server 812. Computer server 812 is configured with an auditing data manager 814 that routes the auditing information to one or more destinations based on predefined policies, such as to a tenant data store 816, a customer data store 818, and/or a customer SOC or Security Information and Event Management (SIEM) provider 820. Tenant data store 816 may include data from multiple tenants, where a tenant-specific key or software partition is used to access tenant-specific data. Additionally or alternatively, customer or tenant-specific data may be sent to data stores that are defined by and controlled by the customer or tenant, such as to customer data store 818 and/or customer SOC/SIEM 820.

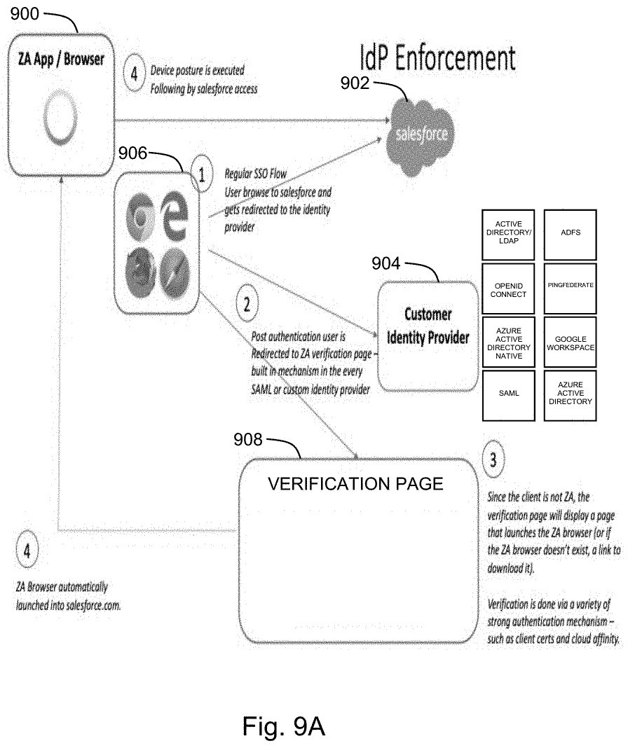

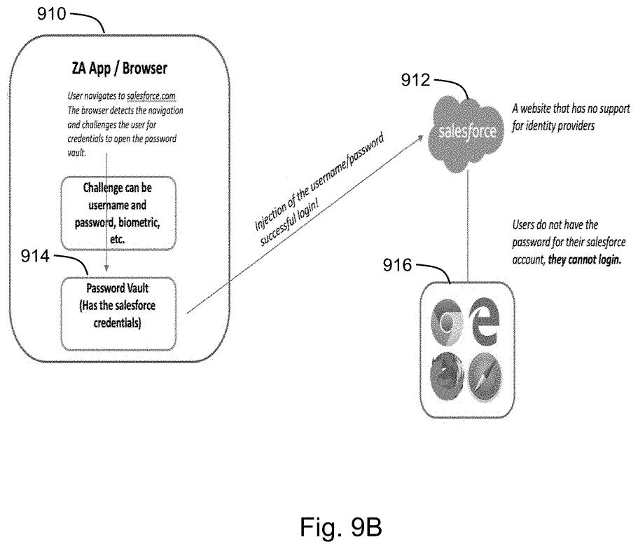

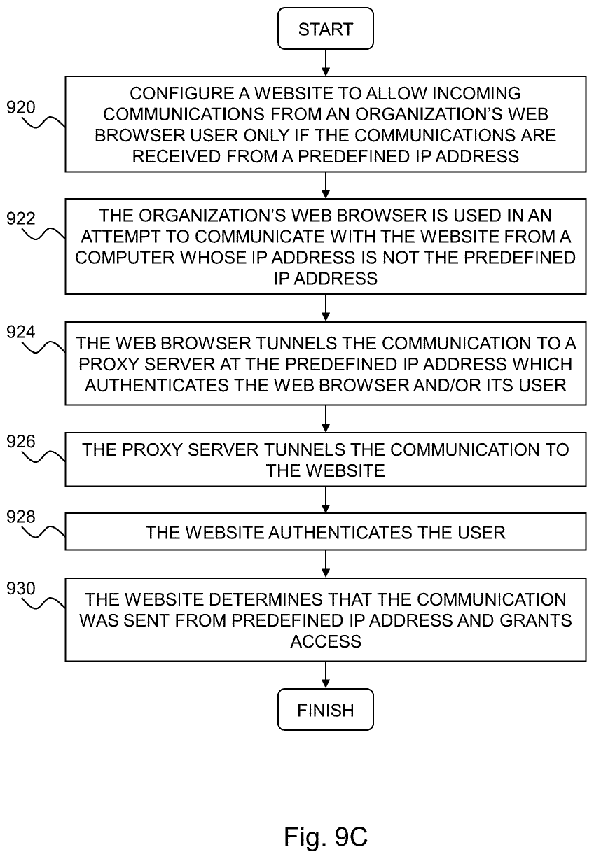

Reference is now made to FIG. 9A, which is a simplified flow diagram illustrating a method of enforcing use of a web browser by employing an identity provider, constructed and operative in accordance with an embodiment of the invention. In FIG. 9A a given employee is required by their employer to use a web browser 900 when accessing a particular website 902, such as salesforce.com, on behalf of the employer, where web browser 900 is configured as described hereinabove with reference to web browser 100 of FIG. 1. Website 902 is configured to redirect the employee to an identity provider (IdP) 904. At step #1 the employee attempts to access website 902 using a web browser 906 that is not configured as web browser 900. Website 902 redirects web browser 906 to IdP 904 which is configured to redirect the employee to a verification webpage 908 after IdP 904 authenticates the employee in accordance with conventional techniques. At step #2, after authenticating the employee, IdP 904 redirects web browser 906 to verification webpage 908 which is configured to determine whether the employee is using web browser 900 to access verification webpage 908. At step #3 verification webpage 908 determines that the employee is not using web browser 900 to access verification webpage 908, such as by determining that information received by verification webpage 908 from web browser 906, such as, for example, one or more of header information, certificates, JSON Web Tokens (JWT), and information identifying the employee, does not match predefined information with which verification webpage 908 is configured and which indicates that the employee is using web browser 900. At step #4 verification webpage 908 then attempts to launch web browser 900 and redirect web browser 900 to website 902. Alternatively, verification webpage 908 provides a link for downloading web browser 900 or a message instructing the user to download web browser 900. If at step #3 verification webpage 908 determines that the employee is using web browser 900 to access verification webpage 908, verification webpage 908 redirects web browser 900 to website 902, e.g., salesforce.com, with the signed SAML assertions to request access to web site 902.

Reference is now made to FIG. 9B, which is a simplified flow diagram illustrating a method of enforcing use of a web browser by employing a password vault, constructed and operative in accordance with an embodiment of the invention. In FIG. 9B a given employee is required by their employer to use a web browser 910 when accessing a particular website 912, such as salesforce.com, on behalf of the employer, where web browser 910 is configured as described hereinabove with reference to web browser 100 of FIG. 1, and is additionally configured as follows. When the employee uses web browser 910 to access website 912, the employee enters invalid login credentials into a login form provided by website 912. When the employee attempts to submit the invalid login credentials to website 912, web browser 910 uses the invalid login credentials to access and decrypt valid login credentials that were previously encrypted and stored in a password vault 914 that is configured with web browser 910, such as where both the invalid login credentials and the valid login credentials were previously provided to management console 114 of FIG. 1 which then encrypted the valid login credentials and provided them to web browser 910. Web browser 910 then submits the valid login credentials to website 912 in place of the invalid login credentials. In this embodiment, if the employee attempts to access website 912 using a web browser 916 that is not configured as web browser 910, and enters the invalid login credentials, the access attempt will fail.

Reference is now made to FIG. 9C, which is a simplified flowchart illustration of a method of enforcing use of a web browser by employing network tunneling, constructed and operative in accordance with an embodiment of the invention. In FIG. 9C a given employee is required by their employer to use a web browser configured as described hereinabove with reference to web browser 100 of FIG. 1, and additionally configured as follows. In step 920 a website, such as salesforce.com, is configured to allow incoming communications from the employee only if the communications are received from a predefined IP address, such as 3.3.3.3. In step 922 the employee uses the web browser in an attempt to communicate with the website from a computer whose IP address is 2.2.2.2. In step 924 the web browser tunnels the communication to IP address 3.3.3.3, which is, for example, a proxy server that is configured to authenticate the employee and/or the web browser in accordance with conventional techniques. In step 926 the proxy server tunnels the communication to the website. In step 928 the website receives the communication and authenticates the employee in accordance with conventional techniques. In step 930 the website further determines that the communication was sent from IP address 3.3.3.3 and grants the employee access.

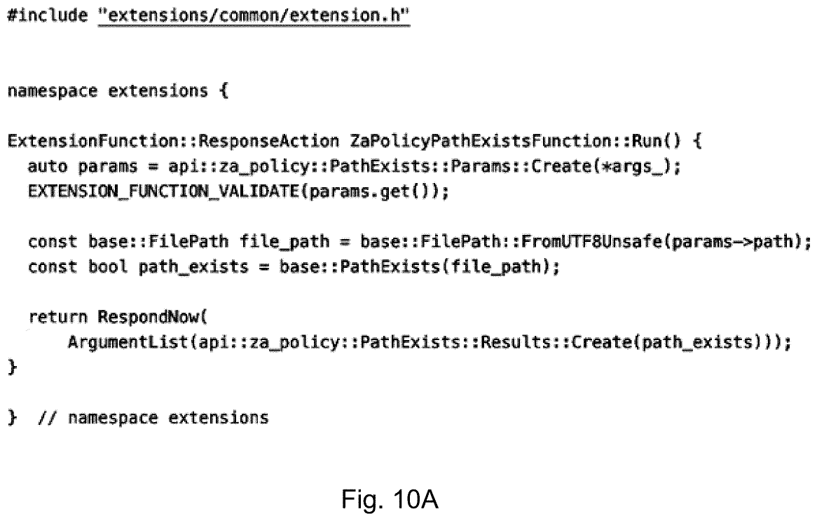

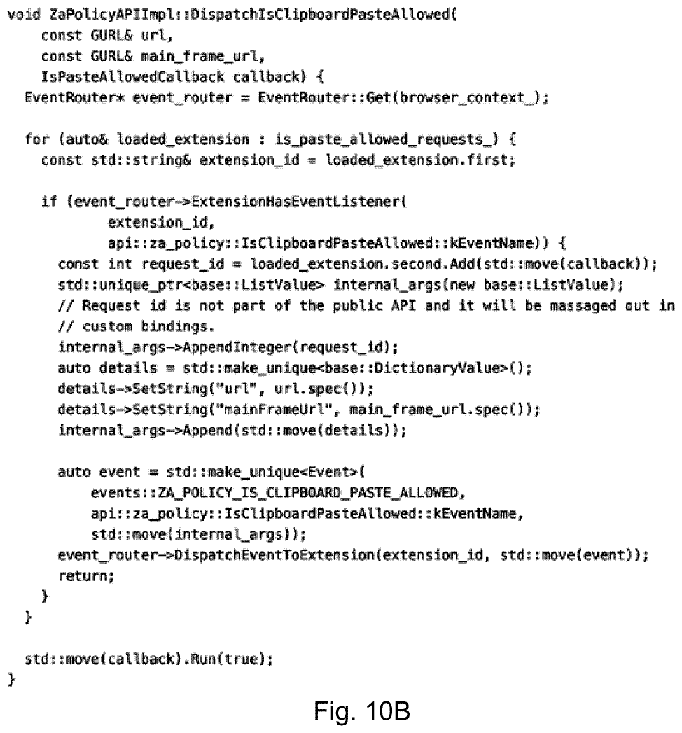

Reference is now made to FIGS. 10A and 10B, which are exemplary code snippets illustrating various methods of extending web browser extension access, constructed and operative in accordance with embodiments of the invention. FIG. 10A shows a code snippet illustrating how to expose PathExists functionality to JavaScript™-based extensions. FIG. 10B shows a code snippet illustrating how to expose clipboard operations to JavaScript™-based extensions.

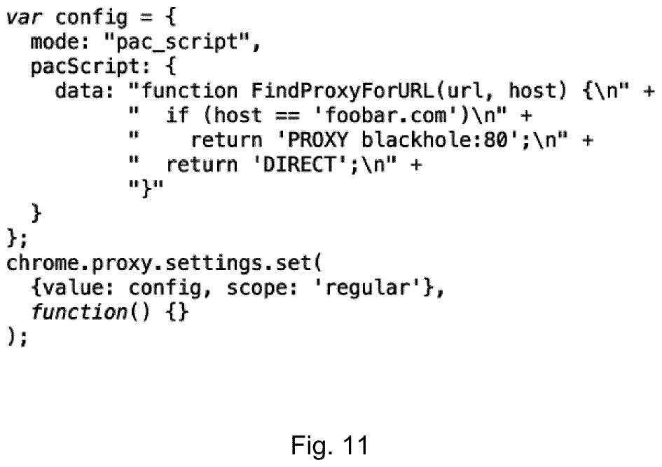

Reference is now made to FIG. 11, which is an exemplary code snippet illustrating a method for configuring a proxy for use with embodiments of the invention. FIG. 11 shows how to dynamically set proxy settings using proxy auto-configuration (PAC) capabilities.

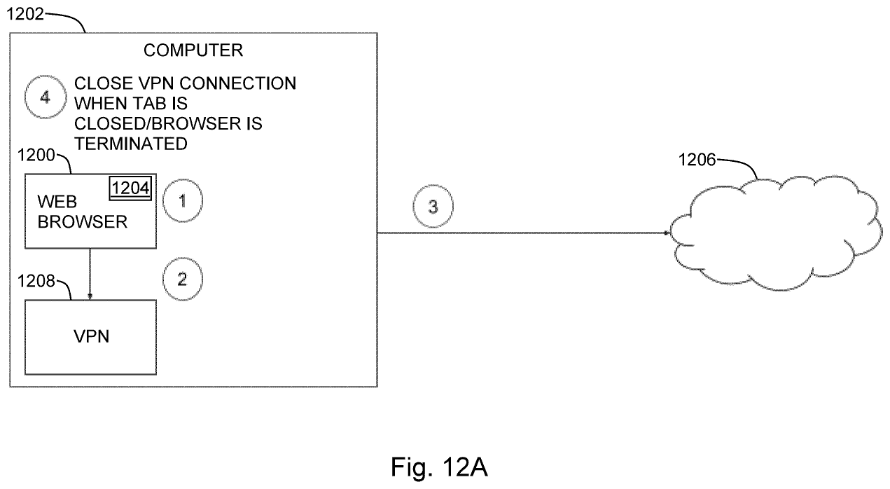

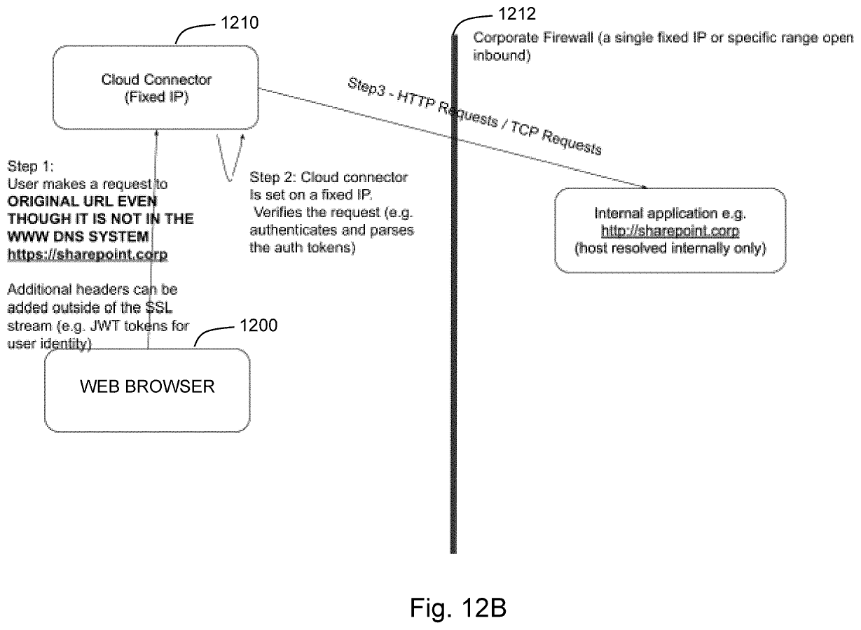

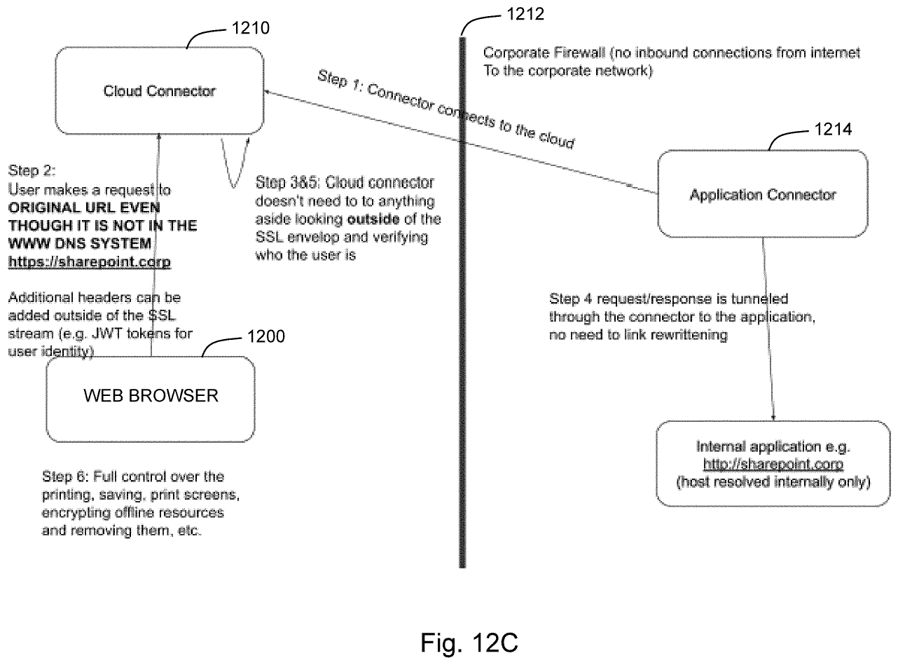

Reference is now made to FIG. 12A, which is a simplified flow diagram illustrating a method of using a web browser with a virtual private network (VPN), constructed and operative in accordance with an embodiment of the invention. FIG. 12A shows a web browser 1200 hosted by a computer 1202, where web browser 1200 is configured as described hereinabove with reference to web browser 100 of FIG. 1, and where web browser 1200 includes a policy engine 1204 configured as described hereinabove with reference to policy engine 102 of FIG. 1. At step #1 web browser 1200 detects an attempt by a user to use web browser 1200 to access an application at a computer network 1206. At step #2 policy engine 1204 determines, in accordance with a predefined policy, that the application is an “internal” application, i.e., an application that has no inbound internet connection from outside of the corporate network or cloud perimeter. and launches a VPN 1208, which may be a VPN that is built-in to web browser 1200, a VPN that is installed on computer 1202, or any other VPN that is accessible to web browser 1200. At step #3 communication between web browser 1200 and computer network 1206 is established via VPN 1208 in accordance with conventional VPN techniques. At step #4 web browser 1200 terminates the VPN connection, such as by being configured to do so upon detecting the closing of a web browser tab that is associated with the VPN session or upon termination of web browser 1200.

Reference is now made to FIG. 12B, which is a simplified flow diagram illustrating a method of using a web browser with a cloud connector, constructed and operative in accordance with an embodiment of the invention. FIG. 12B is configured as described above with reference to FIG. 12A, but where requests to access internal applications are routed to a cloud connector 1210, which may be an implicit proxy, an explicit proxy, or IP-based routing, such as at a fixed IP address. The request may include additional authentication header information outside or inside a Secure Sockets Layer (SSL) stream. Cloud connector 1210 may be configured to decipher SSL streams, such as where the request is an SSL request. Additionally or alternatively, where web browser 1200 controls request headers, additional headers can be added outside of the SSL stream for cloud connector 1210 to be able to route traffic without opening the SSL stream. Cloud connector 1210 then routes the access request to the target application. Where there is a firewall 1212 between cloud connector 1210 and the target application, an incoming port is opened in firewall 1212 to accept incoming communications from the target application.

Reference is now made to FIG. 12C, which is a simplified flow diagram illustrating a method of using a web browser with a cloud connector, constructed and operative in accordance with an embodiment of the invention. FIG. 12C is configured as described above with reference to FIG. 12B, but where instead of opening an incoming port in firewall 1212 for cloud connector 1210 to accept incoming communications directly from the target application, an application connector 1214, which may be configured as a TCP server, is shown with access to the target application. Application connector 1214 opens an outbound connection to cloud connector 1210, and server-to-server authentication may be employed. Cloud connector 1210 is configured to determine which user requests require routing to application connector 1214 or other application connectors. Cloud connector 1210 preferably has multi-tenancy capabilities that support multiple tenants connecting to it at the same time. For example, if tenants A and B connect to the same cloud connector 1210 from different networks, cloud connector 1210 can determine, based on the JWT tokens, headers, and other identifiable information, which tenant is which and route each tenant's traffic to the appropriate destination application connector.

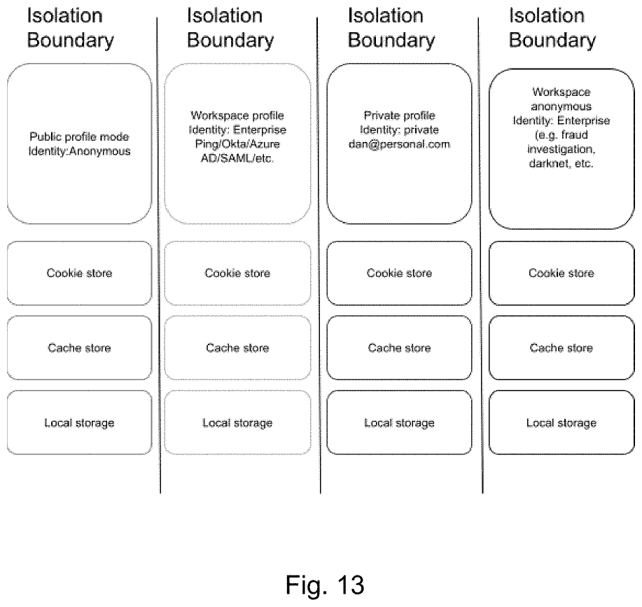

Reference is now made to FIG. 13, which is a simplified diagram illustrating isolation boundaries and multi-profile support, constructed and operative in accordance with an embodiment of the invention. In FIG. 13, as web browser, configured as described hereinabove with reference to web browser 100 of FIG. 1, is additionally configured to implement multiple profiles that are isolated from one another, where each profile has its own data, including policies, cookies, cache, local storage, and any other stateful data, that are not accessible to other profiles. Each profile's data are preferably encrypted using any encryption technique, and are accessible from within its associated profile. Access to the different profiles and associated data is preferably managed by any of the policy mechanisms described hereinabove. Different profiles may be associated with different concurrently-displayed browser tabs, concurrently-executing processes, and/or concurrently-executing browser instances, and a visual indicator may be displayed to allow a user to know what profile is currently being accessed. Some examples of different types of profiles include:
1. A public profile, such as may be associated with an anonymous user identity, where no access is allowed to critical applications;
2. A workspace profile associated with a user who has logged in to the browser using their corporate identity, where policies are enforced to control the user's access to critical applications, and where the user's actions are audited;
3. A private profile, such as may be associated with user when accessing a private website, allowing the user to perform private browsing with anti-tracking and privacy features turned on, where no auditing the user's actions is performed;
4. A workspace anonymous profile associated with a user who has logged in to the browser using their corporate identity, but where the browser is set to perform anonymous browsing, such as for research or law enforcement purposes.

Any aspect of the invention described herein may be implemented in computer hardware and/or computer software embodied in a non-transitory, computer-readable medium in accordance with conventional techniques, the computer hardware including one or more computer processors, computer memories, I/O devices, and network interfaces that interoperate in accordance with conventional techniques.

It is to be appreciated that the term “processor” or “device” as used herein is intended to include any processing device, such as, for example, one that includes a CPU (central processing unit) and/or other processing circuitry. It is also to be understood that the term “processor” or “device” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart illustrations and block diagrams in the drawing figures illustrate the architecture, functionality, and operation of possible implementations of systems, methods, and computer program products according to various embodiments of the invention. In this regard, each block in the flowchart illustrations or block diagrams may represent a module, segment, or portion of computer instructions, which comprises one or more executable computer instructions for implementing the specified logical function(s). In some alternative implementations, the functions noted in a block may occur out of the order noted in the drawing figures. For example, two blocks shown in succession may, in fact, be executed substantially concurrently, or the blocks may sometimes be executed in the reverse order, depending upon the functionality involved. It will also be noted that each block of the flowchart illustrations and block diagrams, and combinations of such blocks, can be implemented by special-purpose hardware-based and/or software-based systems that perform the specified functions or acts.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments.

What is claimed is:

1. A web browser comprising:
a browser and rendering engine configured to send and receive data via a computer network; and
a policy engine configured to implement one or more policies configured to control any aspect of the web browser, the data, a computer that hosts the web browser, and any devices that are accessible to the computer,
wherein the web browser is configured as an executable file that is created by compiling computer software instructions that implement the browser and rendering engine and the policy engine, and
wherein the web browser is configured to require a user of the web browser to be authenticated and one or more policies to be validated before the web browser is allowed to perform one or more predefined operations.

2. The web browser according to claim 1 wherein each of the policies includes one or more policy conditions and one or more policy enforcement actions that are performed when the policy conditions are met.

3. The web browser according to claim 1 wherein the web browser is configured to receive the policies from a source that is external to web browser, wherein the policies are encrypted for decryption using a decryption key that is uniquely associated with an identity that is associated with the user of the web browser, and wherein the decryption key is provided to the web browser after the user is authenticated.

4. The web browser according to claim 3 wherein the web browser is configured to receive from the source browser settings associated with the authenticated user, wherein the browser settings are encrypted for decryption using the decryption key.

5. The web browser according to claim 1 wherein the web browser is configured to at least partially evaluate any of the policies that apply to the data in parallel to receiving the data.

6. The web browser according to claim 1 wherein the web browser is configured to at least partially evaluate any of the policies that apply to the data in parallel to receiving the data and in parallel to providing any portion of the data to the browser and rendering engine.

7. The web browser according to claim 1 wherein any of the policies includes a policy condition that relates to a category associated with a website accessed by the web browser.

8. The web browser according to claim 1 wherein any of the policies includes a policy condition that relates to a risk level associated with a website accessed by the web browser.

9. The web browser according to claim 1 wherein any of the policies includes a policy condition that relates to any characteristic of the computer that hosts the web browser.

10. The web browser according to claim 1 wherein any of the policies includes a policy condition that relates to any characteristic of identity of the user of the web browser.

11. The web browser according to claim 1 wherein any of the policies includes a policy condition that relates to any characteristic of identity of a network that is accessible to the web browser.

12. The web browser according to claim 1 wherein any of the policies includes a policy condition that relates to a source of a Uniform Resource Locator (URL) that is provided to the web browser.

13. The web browser according to claim 1 wherein any of the policies includes a policy enforcement action that requires performing any of data loss prevention (DLP) techniques, antivirus techniques, or antimalware techniques to the data.

14. The web browser according to claim 1 wherein any of the policies includes a policy enforcement action that requires changing or otherwise manipulating the data prior to rendering the data or providing the data to the user.

15. The web browser according to claim 1 wherein any of the policies includes a policy enforcement action that requires, prior to rendering the data or providing the data to the user, converting the data from a first format to at least second format that eliminates a portion of the data, and then converting the converted data to the first format.

16. The web browser according to claim 1 wherein any of the policies includes a policy enforcement action that requires controlling client-side user interactions with a website.

17. The web browser according to claim 1 wherein any of the policies includes a policy enforcement action that requires hiding a browser tab that is closed by the user and showing the hidden browser tab when the user next attempts to access a web site or other content associated with the hidden browser tab.

18. The web browser according to claim 1 wherein any of the policies includes a policy enforcement action that requires disabling a predefined application programming interface (API) of the web browser.

19. The web browser according to claim 1 wherein any of the policies includes a policy enforcement action that requires any of disabling, hiding, or masking a predefined element of a webpage.

20. The web browser according to claim 1 and further comprising an auditor configured to record any actions attempted or performed by the user when using the web browser.

21. The web browser according to claim 1 and further comprising an auditor configured to record any actions attempted or performed by the web browser when the web browser is used by the user.

22. The web browser according to claim 1 and further comprising an auditor configured to record any network activity detectable by the web browser.

23. The web browser according to claim 1 wherein the web browser is specifically configured to operate with one or more target applications.

24. The web browser according to claim 23 wherein the policies are specifically adapted for use with the one or more target applications.

25. The web browser according to claim 1 wherein any of the policies are defined and enforced using robotic process automation (RPA) techniques.

26. The web browser according to claim 1 wherein
the web browser is configured to implement multiple different profiles that are isolated from one another,
each of the profiles has its own data including policies, cookies, cache, and local storage, and
the different profiles are associated with any of different and concurrently-displayed browser tabs, different and concurrently-executing processes, and different and concurrently-executing browser instances.
